(19) United States
(12) Patent Application Publication
(10) Pub. No.: US 2017/0104191 A1
(43) Pub. Date: Apr. 13, 2017

(54) ELECTRICAL STORAGE SYSTEM INCLUDING A SHEET-LIKE DISCRETE ELEMENT, SHEET-LIKE DISCRETE ELEMENT, METHOD FOR PRODUCING SAME, AND USE THEREOF

(71) Applicant: SCHOTT AG, Mainz (DE)

(72) Inventors: Ulrich PEUCHERT, Bodenheim (DE); Rainer LIEBALD, Nauheim (DE); Miriam KUNZE, Saulheim (DE); Thorsten DAMM, Nieder-Olm (DE); Clemens OTTERMANN, Hattersheim (DE); Nikolaus SCHULTZ, Essenheim (DE)

(73) Assignee: SCHOTT AG, Mainz (DE)

(21) Appl. No.: 15/386,078

(22) Filed: Dec. 21, 2016

Related U.S. Application Data
(63) Continuation of application No. PCT/EP2015/064060, filed on Jun. 23, 2015.

(30) Foreign Application Priority Data
Jun. 23, 2014 (DE) 102014008934.7
Jun. 23, 2014 (DE) 102014008935.5
Jul. 23, 2014 (DE) 102014010735.3
Aug. 14, 2014 (DE) 102014111667.4

(51) Int. Cl. H01M 2/02; H01M 10/0525; C03B 17/06; C03C 17/36; C03C 23/00; C03C 3/064; C03C 3/066; C03C 3/089; C03C 3/091; C03C 3/093; C03C 3/11; C03C 3/083; C03C 3/085; C03C 3/097; C03C 3/095; H01M 10/04

(52) U.S. Cl. CPC H01M 2/0287; H01M 2/0207; H01M 10/0436; H01M 10/0525; C03B 17/06; C03C 17/3668; C03C 23/002; C03C 3/064; C03C 3/066; C03C 3/089; C03C 3/091; C03C 3/093; C03C 3/11; C03C 3/083; C03C 3/085; C03C 3/097; C03C 3/095; H01M 2220/30; H01M 2002/0297

(57) ABSTRACT

An electrical storage element is provided that includes a discrete sheet-like element with particularly low transparency to high-energy electrical radiation, preferably in a range of wavelengths from 200 to 400 nm, and to the manufacturing thereof, and also relates to a discrete sheet-like element that exhibits particularly low transparency for high-energy electromagnetic radiation, preferably in a range of wavelengths from 200 to 400 nm, and to the manufacturing thereof.

### CROSS REFERENCE TO RELATED APPLICATIONS

This application is a continuation of International Application No. PCT/EP2015/064060 filed on Jun. 23, 2015, which claims the benefit under 35 U.S.C. 119 of German Application No. 102014008935.5 filed on Jun. 23, 2014, German Application No. 102014008934.7 filed on Jun. 23, 2014, German Application No. 102014010735.3 filed on Jul. 23, 2014, and German Application No. 102014111667.4 filed on Aug. 14, 2014, the entire contents of each of which is incorporated by reference herein.

### BACKGROUND

1. Field of the Invention

Electrical storage systems have long been state of the art and include in particular batteries, but also so-called supercapacitors, short supercaps. In particular so-called lithium-ion batteries are being discussed in the field of novel applications such as electromobility because of the high energy densities that can be realized with them, but they have already been used for a number of years in portable devices such as smartphones or laptop computers. These conventional rechargeable lithium-ion batteries are in particular distinguished by the use of organic solvent-based liquid electrolytes. However, the latter are inflammable and lead to safety concerns regarding the use of the cited lithium-ion batteries. One way of avoiding organic electrolytes is to use solid electrolytes. However, such a solid electrolyte has a conductivity that is usually clearly smaller, i.e. by several orders of magnitude, than that of a corresponding liquid electrolyte. In order to obtain acceptable conductivities and to be able to utilize the advantages of a rechargeable lithium-ion battery, such solid-state batteries are nowadays especially produced in the form of so-called thin film batteries (TFB) or thin film storage elements which find their use in particular in mobile applications, for example in smart cards, in medical technology and sensor technology as well as in smartphones and other applications which require smart, miniaturized and possibly even flexible power sources.

2. Description of Related Art

An exemplary lithium-based thin film storage element has been described in US 2008/0001577 and basically consists of a substrate on which the electronically conductive collectors for the two electrodes are deposited in a first coating step. In the further manufacturing process, the cathode material is first deposited on the cathode collector, usually lithium cobalt oxide, LCO. In the next step, a solid electrolyte is deposited, which is usually an amorphous material including the substances lithium, oxygen, nitrogen, and phosphorus, and which is referred to as LiPON. In the next step, an anode material is deposited so as to be in contact with the substrate, the anode collector, and the solid electrolyte. In particular metallic lithium is used as the anode material. When the two collectors are connected in electrically conductive manner, lithium ions will migrate through the solid-state ion conductor from the anode to the cathode in the charged state, resulting in a current flow from the cathode to the anode through the electrically conductive connection of the two collectors. Vice versa, in the non-charged state migration of the ions from the cathode to the anode can be enforced by applying an external voltage, whereby the battery is charged.

A further thin film storage element is described in US 2001/0032666 A1, by way of example, and also comprises a substrate onto which different functional layers are deposited.

The layers deposited for such a thin film storage element usually have a thickness of about 20 μm or less, typically less than 10 μm or even less than 5 μm; a total thickness of the layer structure can be assumed to be 100 μm or less.

In the context of the present application, thin film storage elements refer to rechargeable lithium-based thin film storage elements and supercaps, by way of example; however the invention is not limited to these systems but may as well be used in other thin film storage elements, e.g. rechargeable and/or printed thin film cells.

A thin film storage element is generally manufactured using complex coating processes also including patterned deposition of the individual materials. Very complex patterning of the exact thin film storage elements is possible, as can be seen from U.S. Pat. No. 7,494,742 B2, for example. In case of lithium-based thin film storage elements, particular difficulties are moreover encountered due to the use of metallic lithium as an anode material because of the high reactivity thereof. For example, metallic lithium has to be handled under preferably water-free conditions since otherwise it would react to form lithium hydroxide and the functionality as an anode would no longer be ensured. Accordingly, a lithium-based thin film storage element must also be protected against moisture by an encapsulation.

U.S. Pat. No. 7,494,742 B2 describes such an encapsulation for the protection of non-stable constituents of a thin film storage element, such as, e.g., lithium or certain lithium compounds. The encapsulation function is here provided by a coating or a system of different coatings which may fulfill further functions as part of the overall design of the battery.

In addition, under the manufacturing conditions of a lithium-based thin film storage element, in particular during annealing or heat treatment steps which are necessary for the formation of crystal structures suitable for lithium intercalation, undesirable side reactions of the mobile lithium ions with the substrate will occur, since the lithium has a high mobility and can easily diffuse into common substrate materials, as described in document US 2010/0104942, for example.

A further issue with thin film storage elements relates to the substrate materials employed. The prior art describes a multiplicity of different substrate materials, such as, for example, silicon, mica, various metals, and ceramic materials. The use of glass is also often mentioned, but essentially without further details on the particular composition or precise properties thereof.

US 2001/0032666 A1 describes a capacitor-type energy storage which may for instance be a lithium-ion battery. Here, semiconductors are mentioned as substrate materials, inter alia.

U.S. Pat. No. 6,906,436 B2 describes a solid state battery in which metal foils, semiconductor materials or plastic films can be used as substrate materials, for example.

U.S. Pat. No. 6,906,436 B2 describes a variety of possibilities for optional substrate materials, for example metals or metal coatings, semiconducting materials or insulators such as sapphire, ceramics, or plastics. Different geometries of the substrate are possible.

In U.S. Pat. No. 7,494,742 B2, metals, semiconductors, silicates, and glass, as well as inorganic or organic polymers are described as substrate materials, inter alia.

U.S. Pat. No. 7,211,351 B2 mentions metals, semiconductors, or insulating materials and combinations thereof as substrates.

US 2008/0001577 A1 mentions semiconductors, metals, or plastic films as substrates.

EP 2434567 A2 mentions, as substrates, electrically conductive materials such as metals, insulating materials such as ceramics or plastics, and semiconducting materials such as, e.g., silicon, and combinations of semiconductors and conductors or more complex structures for adapting the coefficient of thermal expansion. These or similar materials are also mentioned in documents US 2008/0032236 A1, U.S. Pat. No. 8,228,023 B2, and US 2010/0104942 A1.

By contrast, US 2010/0104942 A1 describes, as substrate materials that are relevant in practice, only substrates made of metals or metal alloys having a high melting point, and dielectric materials such as high quartz, silicon wafers, aluminum oxide, and the like. This is due to the fact that for producing a cathode from the usually employed lithium cobalt oxide (LCO), a temperature treatment at temperatures of more than 400° C. or even more than 500° C. is necessary in order to obtain a crystal structure that is particularly favorable for storing Li+ ions in this material, so that materials such as polymers or inorganic materials with low softening points cannot be used. However, metals or metal alloys as well as dielectric materials have several shortcomings. For example, dielectric materials are usually brittle and cannot be used in cost-efficient roll-to-roll processes, while metals or metal alloys, on the other hand, tend to oxidize during a high-temperature treatment of the cathode material. In order to circumvent these difficulties, US 2010/0104942 A1 proposes a substrate made of different metals or silicon, wherein the redox potentials of the combined materials are adapted to each other so that controlled oxide formation occurs.

Also widely discussed is how to circumvent the high temperature resistance of the substrate as required, for example, in the aforementioned US 2010/0104942 A1. By adapting process conditions, for example, substrates with a temperature resistance of 450° C. or below can be used. However, prerequisites for this are deposition methods in which the substrate is heated and/or the sputtering gas mixture of O₂ and Ar is optimized and/or a bias voltage is applied and/or a second sputtering plasma is applied in the vicinity of the substrate. This is discussed, for example, in US 2014/0030449 A1, in Tintignac et al., Journal of Power Sources 245 (2014), 76-82, or else in Ensling, D., Photoelectron spectroscopy examination of the electronic structure of thin lithium cobalt oxide layers, dissertation, Technical University of Darmstadt, 2006. In general, however, such process engineering adaptations are expensive and, depending on the processing, are hardly implementable in a cost-effective manner, especially if in-line coating of wafers is envisaged.

US 2012/0040211 A1 describes, as a substrate, a glass film having a thickness of at most 300 μm and a surface roughness of not more than 100 Å. This low surface roughness is required because the layers of a thin film storage element generally have very low thicknesses. Even small unevenness of the surface may have a critical adverse effect on the functional layers of the thin film storage element and may thus result in failure of the battery as a whole.

WO 2014/062676 A1 describes thin film batteries comprising a glass or ceramic substrate having a coefficient of thermal expansion between 7 and 10 ppm/K in a range from 25 to 800° C., which is said to ensure a particularly crack-free structure especially of the cathode of such a battery even in case of increased thicknesses of the cathode layer. Information on the roughness of the substrate, its transmission properties and thickness variations are not found in this document.

In summary, problems of conventional thin film storage elements are related to the corrosion susceptibility of the employed materials, in particular if metallic lithium is used, which implies complex layer structures and hence causes high costs, and also to the type of the substrate which should in particular be non-conductive but flexible, should exhibit high temperature resistance and should be inert to the most possible extent to the functional layers of the storage element used, and moreover should allow for deposition of layers preferably free of defects and with good layer adhesion on the substrate. However, it has been found that even with substrates having a particularly low surface roughness such as the glass film proposed in US 2012/0040211 A1, for example, or with a substrate similar to WO 2014/062676 A1 which has a thermal expansion coefficient adapted to the cathode layer, failure of layers occurs as a result of cracks and/or detachment of the layers, as described in US 2014/0030449 A1 for example. The method for avoiding high annealing temperatures proposed therein, namely by applying a bias voltage when creating the lithium cobalt oxide layer, however, is difficult to implement in the common in-line processes for producing thin film storage elements, as already described above, so that from a process engineering point of view it is more favorable to use a substrate having a correspondingly high temperature resistance.

Moreover, when being manufactured the individual electrical thin-film storage elements are usually deposited on a large wafer, and expensive masking techniques are used before the thin-film storage elements are singularized by a separation or cutting process.

Processing of the substrate for singularization of storage elements deposited in a coating process or for via connecting may for instance be effected using a laser process, as described in DE 10 2011 084 128 A1 by way of example for materials used in energy engineering, inter alia, such as thin glass. In this way, a special cutting edge with a very smooth surface free of microcracks is obtained. In terms of composition, the employed glasses are glasses free of alkali metals and titanium.

### SUMMMARY

An object of the invention is to provide an electrical storage element which is improved in terms of durability and flexibility of design.

Another object of the invention is to provide a sheet-like discrete element for use in an electrical storage system, which allows for processing using optical energy sources, in particular even processing of regions located behind the sheet-like discrete element as seen in optical beam direction.

A further object of the invention is to provide an electrical storage element, in particular a thin film storage element, which mitigates the shortcomings of the current prior art and provides for a cost-effective and efficient manufacturing of thin film storage elements. A further object of the invention is to provide a sheet-like element for use in an electrical storage element, and a way for producing same and use thereof.

The object of the invention is achieved in a surprisingly simple way by an electrical storage system disclosed herein.

Namely, it has surprisingly been found that particularly good properties of an electrical storage element can be achieved if the electrical storage element includes at least one sheet-like discrete element that exhibits particularly low transparency for high-energy electromagnetic radiation, preferably in a range of wavelengths from 200 to 400 nm. This is due to the fact that such a material absorbs particularly well the energy supplied by a high-energy laser. In this way, excellent cutting edges are obtained which are substantially free of microcracks.

Furthermore, the reduced transparency of the sheet-like discrete element allows for easy processing of the layer package subsequently to the deposition of the functional layers.

For example it is possible to selectively subsequently treat individual layers by using focused or two-dimensional UV radiation. The subsequently introduced energy results in a particularly good layer structure of the overall configuration of a thin film storage element and increases the durability of the energy storage device in a surprisingly simple way.

For this reason, a further aspect of the invention comprises a method for producing a thin film storage element according to the invention.

In the context of the present invention, such a substrate of reduced transparency for high-energy electrical radiation is provided by a sheet-like discrete element.

In the context of the present application a shaped body is considered as being sheet-like if the dimension of the element in one spatial direction is smaller by at least half an order of magnitude than in the two other spatial directions. In the context of the present application a shaped body is considered as being discrete if it is separable as such from the electrical storage system under consideration, that is to say it may in particular as well be provided alone.

The optical processing or processing using high-energy electromagnetic radiation of the electrical storage element is preferably accomplished using high-energy optical energy sources such as, for example, excimer lasers.

The sheet-like discrete element is preferably distinguished by reduced transparency at least at one wavelength that is characteristic for so-called excimer lasers.

In the context of the invention, reduced transparency refers to a transmittance of less than 50% for a thickness of the sheet-like discrete element of 30 μm.

Typical excimer lasers with their characteristic wavelengths are listed below:

| | |
|---|---|
| KrCl laser | 222 nm |
| KrF laser | 248.35 nm |
| XeBr laser | 282 nm |
| XeCl laser | 308 nm |
| XeF laser | 351 nm. |

However, conventional UV lamps may also be employed as further UV sources, such as, e.g., a mercury-vapor lamp.

Furthermore, the sheet-like discrete element is distinguished by a total thickness variation (ttv) in a range of <25 μm, preferably of <15 μm, more preferably of <10 μm, and most preferably of <5 μm based on the wafer or substrate size used, based on wafer or substrate sizes in a range of >100 mm in diameter, in particular with a lateral dimension of 100 mm×100 mm, preferably based on wafer or substrate sizes in a range of >200 mm in diameter, in particular with a lateral dimension of 200 mm×200 mm, and more preferably based on wafer or substrate sizes in a range of >400 mm in diameter, in particular with a lateral dimension of 400 mm×400 mm. Thus, the indication typically refers to wafer or substrate sizes in a range of >100 mm in diameter or a size of 100 mm×100 mm, preferably >200 mm in diameter or a size of 200 mm×200 mm, and more preferably >400 mm in diameter or a size of 400 mm×400 mm.

The sheet-like discrete element of the invention has a thickness of not more than 2 mm, preferably less than 1 mm, more preferably less than 500 μm, and yet more preferably of less than or equal to 200 μm. Most preferred is a thickness of the substrate of not more than 100 μm, while thicknesses of 10 μm or in particular 5 μm require extremely sophisticated handling during subsequent processing and are avoided in conjunction with the present invention, so that the discrete sheet-like element will have a thickness of at least 5 μm.

In one embodiment of the invention, the sheet-like discrete element exhibits a water vapor transmission rate (WVTR) of <10⁻³ g/(m²·d), preferably of <10⁻⁵ g/(m²·d), and most preferably of <10⁻⁶ g/(m²·d).

In a further embodiment, the specific electrical resistance of the sheet-like discrete element at a temperature of 350° C. and at an alternating current with a frequency of 50 Hz is greater than 1.0*10⁶ Ohm·cm.

The sheet-like discrete element is furthermore characterized by a maximum temperature resistance of at least 300° C., preferably at least 400° C., most preferably at least 500° C., and by a coefficient of linear thermal expansion α in a range from 2.0*10⁻⁶/K to 10*10⁻⁶/K, preferably from 2.5*10⁻⁶/K to 9.5*10⁻⁶/K, and most preferably from 3.0*10⁻⁶/K to 9.5*10⁻⁶/K. It has been found that particularly good layer qualities can be achieved in a thin film storage element when the following relationship applies to the maximum load temperature θ_{Max} and the coefficient of linear thermal expansion α: 600·10⁻⁶≦θₘₐₓ·α≦8000·10⁻⁶, particularly preferably 800·10⁻⁶≦θₘₐₓ·α≦5000·10⁻⁶.

In the context of the present application, the maximum load temperature θ_{Max} is considered as a temperature at which the functional integrity of the material is still fully ensured and at which decomposition and/or degradation reactions of the material have not yet started. Naturally this temperature is defined differently depending on the material used. For oxidic crystalline materials, the maximum load temperature is usually given by the melting point; for glasses usually the glass transition temperature T_{g} is assumed, however, for organic glasses the decomposition temperature may even be below T_{g}; and for metals or metal alloys the maximum load temperature can be approximately indicated by the melting point, unless the metal or the metal alloy reacts in a degradation reaction below the melting point.

Unless otherwise stated, the linear coefficient of thermal expansion α is given for a range from 20 to 300° C. The notations α and α₍₂₀₋₃₀₀₎ are used synonymously in the context of the present application. The given value is the nominal coefficient of mean linear thermal expansion according to ISO 7991, which is determined in static measurement.

The sheet-like element of the invention consists of at least one oxide or a mixture or compound of oxides.

In a further embodiment of the invention, this at least one oxide is SiO₂.

In a further embodiment of the invention, the sheet-like element is made of glass. Within the context of the present application, the term ‘glass’ refers to a material which is essentially inorganic in nature and predominantly consists of compounds of metals and/or semimetals with elements of groups VA, VIA, and VIIA of the periodic table of elements, but preferably with oxygen, and which is distinguished by an amorphous state, i.e. a three-dimensional state without periodical order, and by a specific electrical resistance at a temperature of 350° C. and alternating current with a frequency of 50 Hz of greater than 1.0*10⁶ Ohm·cm. Hence, in particular the amorphous material LiPON which is used as a solid-state ion conductor is not considered to be a glass in the sense of the present application.

The transformation temperature T_{g} is defined by the point of intersection of the tangents to the two branches of the expansion curve when measuring with a heating rate of 5 K/min. This corresponds to a measurement according to ISO 7884-8 or DIN 52324, respectively.

According to a further embodiment of the invention, the sheet-like element of the invention is obtained by a melting process.

Preferably, the sheet-like element is formed into a sheet-like shape in a shaping process following the melting process. This shaping may be performed directly following the melting (known as hot forming). However, it is as well possible that first a solid, essentially non-shaped body is obtained which is transformed into a sheet-like state only in a further step, by being reheated.

If the shaping of the sheet-like element is accomplished by a hot forming process, this will, according to one embodiment of the invention, involve drawing processes, for example down-draw, up-draw, or overflow fusion processes. However, other hot forming processes are also possible, for example shaping in a float process.

The following tables give some exemplary compositions of sheet-like elements according to the invention.

### EXAMPLARY EMBODIMENT 1

The composition of the sheet-like discrete element is given, by way of example, by the following composition, in wt %:

| | |
|---|---|
| SiO₂ | 30 to 85 |
| B₂O₃ | 3 to 20 |
| Al₂O₃ | 0 to 15 |
| Na₂O | 3 to 15 |
| K₂O | 3 to 15 |
| ZnO | 0 to 12 |
| TiO₂ | 0.5 to 10 |
| CaO | 0 to 0.1. |

### EXAMPLARY EMBODIMENT 2

Another sheet-like discrete element is given, by way of example, by the following composition, in wt %:

| | |
|---|---|
| 1. SiO₂ | 64.0 |
| 2. B₂O₃ | 8.3 |
| 3. Al₂O₃ | 4.0 |
| 4. Na₂O | 6.5 |
| 5. K₂O | 7.0 |
| 6. ZnO | 5.5 |
| 7. TiO₂ | 4.0 |
| 8. Sb₂O₃ | 0.6 |
| 9. Cl⁻ | 0.1. |

With this composition, the following properties of the sheet-like discrete element are obtained:

| | |
|---|---|
| α₍₂₀₋₃₀₀₎ | 7.2 · 10⁻⁶/K |
| T_{g} | 557° C. |
| Density | 2.5 g/cm³. |

### EXEMPLARY EMBODIMENT 3

Another sheet-like discrete element is given, by way of example, by the following composition, in wt %

| | |
|---|---|
| SiO₂ | 65 +/− 5 |
| Al₂O₃ | 22 +/− 5 |
| Na₂O | 1 +/− 1 |
| Li₂O | 4 +/− 1 |
| MgO | 1 +/− 1 |
| BaO | 2 +/− 2 |
| ZnO | 2 +/− 2 |
| TiO₂ | 3 +/− 2 |
| ZrO₂ | 2 +/− 2. |

### EXEMPLARY EMBODIMENT 4

Another sheet-like discrete element is given, by way of example, by the following composition, in wt %:

| | |
|---|---|
| SiO₂ | 65 |
| Al₂O₃ | 22 |
| Na₂O | 0.5 |
| Li₂O | 3.5 |
| MgO | 0.5 |
| BaO | 2 |
| ZnO | 2 |
| TiO₂ | 2.5 |
| ZrO₂ | 2. |

With this composition, the following properties of the sheet-like discrete element are obtained:

| | |
|---|---|
| α₍₂₀₋₃₀₀₎ | 4 · 10⁻⁶/K |
| T_{g} | 690° C. |

### EXEMPLARY EMBODIMENT 5

Another sheet-like discrete element is given, by way of example, by the following composition, in wt %:

| | |
|---|---|
| SiO₂ | 50 to 70 |
| Al₂O₃ | 17 to 27 |
| Li₂O | 0 to 5 |
| Na₂O | 0 to 5 |
| K₂O | 0 to 5 |
| MgO | 0 to 5 |
| ZnO | 0 to 5 |
| TiO₂ | 0 to 5 |
| ZrO₂ | 0 to 5 |
| Ta₂O₅ | 0 to 5 |
| BaO | 0 to 5 |
| SrO | 0 to 5 |
| P₂O₅ | 0 to 5 |
| Fe₂O₃ | 0 to 5 |
| CeO₂ | 0 to 5 |
| Bi₂O₃ | 0 to 5 |
| WO₃ | 0 to 5 |
| MoO₃ | 0 to 5. |

### BRIEF DESCRIPTION OF THE DRAWINGS

FIG. 1 schematically shows an electrical storage system according to the present invention;

FIG. 2 schematically illustrates a sheet-like discrete element according to the present invention;

FIG. 3 shows transmittance data for a sheet-like discrete element of the invention with three different thicknesses; and

FIG. 4 shows transmittance data for a sheet-like discrete element of the invention with two different thicknesses.

### DETAILED DESCRIPTION

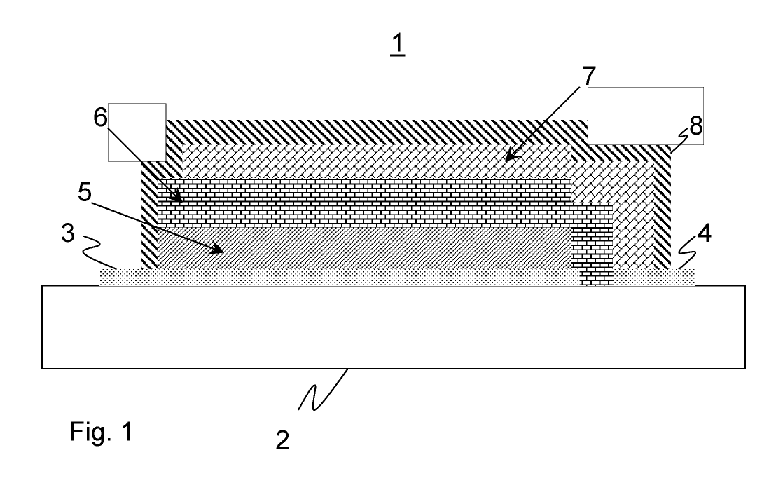

FIG. 1 schematically shows an electrical storage system 1 according to the present invention. It comprises a sheet-like discrete element 2 which is used as a substrate. A sequence of different layers is applied on the substrate. By way of example and without being limited to the present example, first the two collector layers are applied on the sheet-like discrete element 2, cathode collector layer 3, and anode collector layer 4. Such collector layers usually have a thickness of a few micrometers and are made of a metal, for example of copper, aluminum, or titanium. Superimposed on collector layer 3 is cathode layer 5. If the electrical storage system 1 is a lithium-based thin film battery, the cathode is made of a lithium/transition metal compound, preferably an oxide, for example of LiCoO₂, of LiMnO₂, or else of LiFePO₄. Furthermore, the electrolyte 6 is applied on the substrate and is at least partially overlapping cathode layer 5. In the case of a lithium-based thin film battery, this electrolyte is mostly LiPON, a compound of lithium with oxygen, phosphorus, and nitrogen. Furthermore, the electrical storage system 1 comprises an anode 7 which may for instance be made of lithium titanium oxide or else of metallic lithium. Anode layer 7 is at least partially overlapping electrolyte layer 6 and collector layer 4. Furthermore, the electrical storage system 1 comprises an encapsulation layer 8.

In the context of the present invention, any material which prevents or greatly reduces the attack of fluids or other corrosive materials on the electrical storage system 1 is considered as an encapsulation or sealing of the electrical storage system 1.

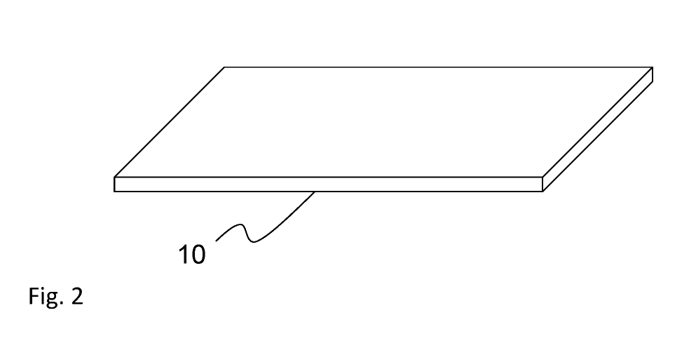

FIG. 2 schematically illustrates a sheet-like discrete element according to the present invention, here in the form of a sheet-like shaped body 10. In the context of the present invention, a shaped body is referred to as being sheet-like or a sheet if its dimension in one spatial direction is not more than half of that in the two other spatial directions. A shaped body is referred to as a ribbon in the present invention if it has a length, width, and thickness for which the following relationship applies: the length is at least ten times larger than the width which in turn is at least twice as large as the thickness.

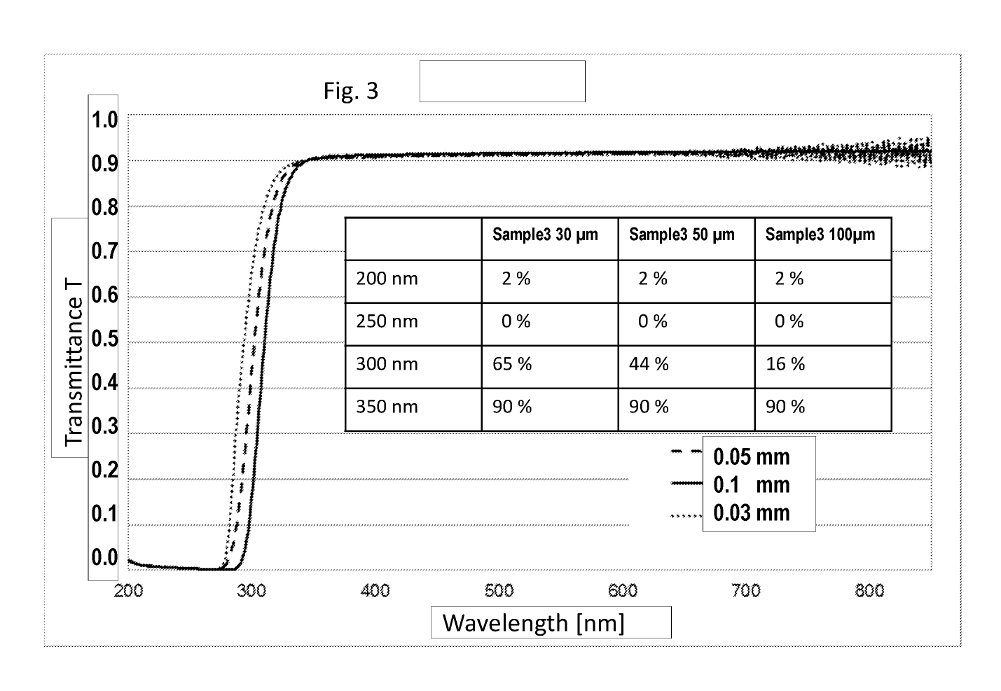

FIG. 3 shows transmittance data for a sheet-like discrete element of the invention according to the composition of exemplary embodiment 2, with three different thicknesses. At rather large wavelengths, clearly perceptible interference effects occur, which are caused by measurement technology and thus do not represent a characteristic of the discrete sheet-like element.

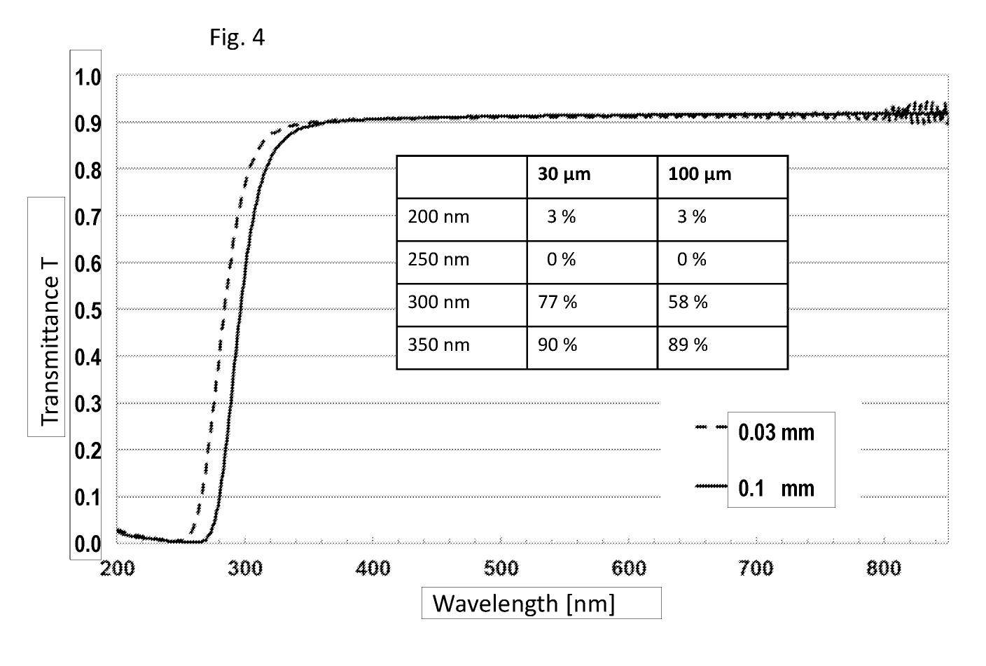

FIG. 4 shows transmittance data for a sheet-like discrete element of the invention according to the composition of exemplary embodiment 4, with two different thicknesses. At rather large wavelengths, clearly perceptible interference effects occur, which are caused by measurement technology and thus do not represent a characteristic of the discrete sheet-like element.

Thus, as part of the present disclosure an electrical storage system is furthermore described, which comprises at least one sheet-like discrete element which in particular in case of a thickness of 30 μm has a transmittance in a range from 200 nm to 270 nm of 20% or less transmittance, and/or of 2.0% or less in particular preferably at 222 nm, of 1.0% or less in particular preferably at 248 nm, of 50% or less in particular preferably at 282 nm, of 85% or less in particular preferably at 308 nm, and of 92% or less in particular preferably at 351 nm, and in particular in case of a thickness of 100 μm has a transmittance in the range from 200 nm to 270 nm of 3% or less, and/or of 3.0% or less in particular preferably at 222 nm, of 3.0% or less in particular preferably at 248 nm, of 20% or less in particular preferably at 282 nm, of 75% or less in particular preferably at 308 nm, and of 92% or less in particular preferably at 351 nm.

Also disclosed is an electrical storage system that comprises at least one sheet-like discrete element which in particular in case of a thickness of 30 μm has a transmittance in the range from 200 nm to 270 nm of 15% or less, and/or of 2.0% or less in particular preferably at 222 nm, of 1.0% or less in particular preferably at 248 nm, of 10% or less in particular preferably at 282 nm, of 80% or less in particular preferably at 308 nm, and of 92% or less in particular preferably at 351 nm.

Also disclosed is an electrical storage system that comprises at least one sheet-like discrete element, wherein the at least one sheet-like discrete element exhibits a total thickness variation of not more than 25 μm, preferably of not more than 15 μm, more preferably of not more than 10 μm, and most preferably of not more than 5 μm, based on wafer or substrate sizes in a range of >100 mm in diameter, in particular with a lateral dimension of 100 mm×100 mm, preferably based on wafer or substrate sizes in a range of >200 mm in diameter, in particular with a lateral dimension of 200 mm×200 mm, and more preferably based on wafer or substrate sizes in a range of >400 mm in diameter, in particular with a lateral dimension of 400 mm×400 mm.

Also disclosed is an electrical storage system that comprises at least one sheet-like discrete element, wherein the at least one sheet-like discrete element exhibits a water vapor transmission rate (WVTR) of <10⁻³ g/(m²·d), preferably of <10⁻⁶ g/(m²·d), and more preferably of <10⁻⁶ g/(m²·d).

Also disclosed is an electrical storage system in which the sheet-like discrete element has a thickness of less than 2 mm, preferably less than 1 mm, more preferably less than 500 μm, yet more preferably of less than or equal to 200 μm, and most preferably of less than or equal to 100 μm.

Also disclosed is an electrical storage system that comprises at least one sheet-like discrete element, wherein the at least one sheet-like discrete element has a specific electrical resistance at a temperature of 350° C. and at alternating current with a frequency of 50 Hz of greater than 1.0*10⁶ Ohm·cm.

Also disclosed is an electrical storage system that comprises at least one sheet-like discrete element, wherein the at least one sheet-like discrete element exhibits a maximum load temperature θ_{Max} of at least 300° C., preferably at least 400° C., most preferably at least 500° C.

Also disclosed is an electrical storage system that comprises at least one sheet-like discrete element, wherein the at least one sheet-like discrete element has a coefficient of linear thermal expansion α in a range from 2.0*10⁻⁶/K to 10*10⁻⁶/K, preferably from 2.5*10⁻⁶/K to 9.5*10⁻⁶/K, and most preferably from 3.0*10⁻⁶/K to 9.5*10⁻⁶/K.

Also disclosed is an electrical storage system that comprises at least one sheet-like discrete element, wherein the following relationship applies to a product of maximum load temperature θ_{Max}, in ° C., and coefficient of linear thermal expansion α of the at least one sheet-like discrete element: 600·10⁻⁶≦θ_{Max}·α≦8000·10⁻⁶, particularly preferably 800·10⁻⁶≦θ_{Max}·α≦5000·10⁻⁶.

Also disclosed is an electrical storage system in which the at least one sheet-like discrete element comprises at least one oxide or a mixture or compound of a plurality of oxides.

Also disclosed is an electrical storage system in which the at least one sheet-like discrete element contains SiO₂ as an oxide.

Also disclosed is an electrical storage system in which the at least one sheet-like discrete element is a glass.

Also disclosed is an electrical storage system in which the at least one sheet-like discrete element was formed into a sheet-like shape by a melting process with a subsequent shaping process.

Also disclosed is an electrical storage system in which the at least one sheet-like discrete element was formed by a shaping process which is a drawing process.

Also disclosed is a sheet-like discrete element for use in an electrical storage system, which sheet-like discrete element in particular in case of a thickness of 30 μm has a transmittance in a range from 200 nm to 270 nm of 20% or less transmittance, and/or of 2.0% or less in particular preferably at 222 nm, of 1.0% or less in particular preferably at 248 nm, of 50% or less in particular preferably at 282 nm, of 85% or less in particular preferably at 308 nm, and of 92% or less in particular preferably at 351 nm, and in particular in case of a thickness of 100 μm has a transmittance in the range from 200 nm to 270 nm of 3% or less, and/or of 3.0% or less in particular preferably at 222 nm, of 3.0% or less in particular preferably at 248 nm, of 20% or less in particular preferably at 282 nm, of 75% or less in particular preferably at 308 nm, and of 92% or less in particular preferably at 351 nm.

Also disclosed is a sheet-like discrete element for use in an electrical storage system, which in particular in case of a thickness of 30 μm has a transmittance in the range from 200 nm to 270 nm of 15% or less, and/or a transmittance of 2.0% or less in particular preferably at 222 nm, of 1.0% or less in particular preferably at 248 nm, of 10% or less in particular preferably at 282 nm, of 80% or less in particular preferably at 308 nm, and of 92% or less in particular preferably at 351 nm.

Also disclosed is a sheet-like discrete element for use in an electrical storage system, the sheet-like discrete element exhibiting a thickness variation of not more than 25 μm, preferably of not more than 15 μm, more preferably of not more than 10 μm, and most preferably of not more than 5 μm, based on wafer or substrate sizes in a range of >100 mm in diameter, in particular with a lateral dimension of 100 mm×100 mm, preferably based on wafer or substrate sizes in a range of >200 mm in diameter, in particular with a lateral dimension of 200 mm×200 mm, and more preferably based on wafer or substrate sizes in a range of >400 mm in diameter, in particular with a lateral dimension of 400 mm×400 mm.

Also disclosed is a sheet-like discrete element for use in an electrical storage system, the sheet-like discrete element exhibiting a water vapor transmission rate (WVTR) of <10⁻³ g/(m²·d), preferably of <10⁻⁶ g/(m²·d), and more preferably of <10⁻⁶ g/(m²·d).

Also disclosed is a sheet-like discrete element for use in an electrical storage system, the sheet-like discrete element having a thickness of less than 2 mm, preferably less than 1 mm, more preferably less than 500 μm, yet more preferably of less than or equal to 200 μm, and most preferably of not more than 100 μm.

Also disclosed is a sheet-like discrete element for use in an electrical storage system, the sheet-like discrete element having a specific electrical resistance at a temperature of 350° C. and at alternating current with a frequency of 50 Hz of greater than 1.0*10⁶ Ohm·cm.

Also disclosed is a sheet-like discrete element for use in an electrical storage system, the sheet-like discrete element exhibiting a maximum load temperature θ_{Max} of at least 300° C., preferably at least 400° C., most preferably at least 500° C.

Also disclosed is a sheet-like discrete element for use in an electrical storage system, the sheet-like discrete element having a coefficient of linear thermal expansion α in a range from 2.0*10⁻⁶/K to 10*10⁻⁶/K, preferably from 2.5*10⁻⁶/K to 9.5*10⁻⁶/K, and most preferably from 3.0*10⁻⁶/K to 9.5*10⁻⁶/K.

Also disclosed is a sheet-like discrete element for use in an electrical storage system, wherein the following relationship applies to a product of maximum load temperature θ_{Max}, in ° C., and coefficient of linear thermal expansion α of the at least one sheet-like discrete element: 600·10⁻⁶≦θ_{Max}·α≦8000·10⁻⁶, particularly preferably 800·10⁻⁶≦θ_{Max}·α≦5000·10⁻⁶.

Also disclosed is a sheet-like discrete element for use in an electrical storage system, the sheet-like discrete element comprising at least one oxide or a mixture or compound of a plurality of oxides.

Also disclosed is a sheet-like discrete element for use in an electrical storage system in which the at least one oxide is SiO₂.

Also disclosed is a sheet-like discrete element for use in an electrical storage system in which the element is made of glass.

Also disclosed is a sheet-like discrete element for use in an electrical storage system in which the element was formed into a sheet-like shape by a melting process with a subsequent shaping process.

Also disclosed is a sheet-like discrete element for use in an electrical storage system in which the subsequent shaping process comprises a drawing process.

Also disclosed is a method for producing a thin film storage element that comprises at least one sheet-like discrete element, the method comprising:
providing a sheet-like discrete element;
depositing at least one functional layer of a thin film storage element;
processing the at least one functional layer by focusing UV light onto the sheet-like discrete element which thereby absorbs the UV radiation and converts it into heat energy, which heat energy serves for thermal post-treatment of the at least one functional layer.

Also within the scope of the invention are discrete sheet-like elements of greater or smaller thickness, if these thicker or thinner discrete sheet-like elements meet the values of the disclosure when converted into a thickness of 30 μm.

Thicker substrates may be thinned to a thickness of 30 μm in order to determine whether they fall into the scope of protection.

Thinner discrete elements may also be brought to a thickness of 30 μm by being stacked and optionally thinned, if necessary, so that instead of the converting a physical measurement of transmittance can be performed in order to determine whether these thinner substrates fall into the scope of protection.

### LIST OF REFERENCE NUMERALS

1 Electrical storage system
2 Sheet-like discrete element used as a substrate
3 Cathode collector layer
4 Anode collector layer
5 Cathode
6 Electrolyte
7 Anode
8 Encapsulation layer
10 Sheet-like discrete element in the form of a sheet-like shaped body

What is claimed is:

1. An electrical storage system, comprising:
a sheet-like discrete element,
wherein the sheet-like discrete element has a transmittance selected from the group consisting of: 20% or less in a range from 200 nm to 270 nm at a thickness of 30 μm, 2.0% or less at 222 nm at a thickness of 30 μm, 1.0% or less at 248 nm at a thickness of 30 μm, 50% or less at 282 nm at a thickness of 30 μm, 85% or less at 308 nm at a thickness of 30 μm, 92% or less at 351 nm at a thickness of 30 μm, 3% or less in a range from 200 nm to 270 nm at a thickness of 100 μm, 3.0% or less at 222 nm at a thickness of 100 μm, 3.0% or less at 248 nm at a thickness of 100 μm, 20% or less at 282 nm at a thickness of 100 μm, 75% or less at 308 nm at a thickness of 100 μm, and 92% or less at 351 nm at a thickness of 100 μm,
wherein the sheet-like discrete element has a total thickness variation of not more than 25 μm based on wafer or substrate sizes in a range of >100 mm in diameter, and
wherein the sheet-like discrete element comprises a composition range, in wt %, of:

| Component | Range |
|---|---|
| SiO₂ | 30-85 |
| Al₂O₃ | 0-15 |
| B₂O₃ | 3-20 |
| Na₂O | 3-15 |
| K₂O | 3-15 |
| CaO | 0-0.1 |
| ZnO | 0-12 |
| TiO₂ | 0.5-10. |

2. The electrical storage system as claimed in claim 1, wherein the transmittance is selected from the group consisting of 15% or less in the range from 200 nm to 270 nm at a thickness of 30 μm, 10% or less at 282 nm at a thickness of 30 μm, and 80% or less at 308 nm a thickness of 30 μm.

3. The electrical storage system as claimed in claim 1, wherein the sheet-like discrete element exhibits a water vapor transmission rate (WVTR) of <10⁻³ g/(m²·d).

4. The electrical storage system as claimed in claim 1, wherein the sheet-like discrete element has a thickness of less than 2 mm.

5. The electrical storage system as claimed in claim 1, wherein the sheet-like discrete element has a thickness of less than or equal to 100 μm.

6. The electrical storage system as claimed in claim 1, wherein the sheet-like discrete element has a specific electrical resistance at a temperature of 350° C. and at alternating current with a frequency of 50 Hz of greater than 1.0*10⁶ Ohm·cm.

7. The electrical storage system as claimed in claim 1, wherein the sheet-like discrete element exhibits a maximum load temperature θ_{Max} of at least 300° C.

8. The electrical storage system as claimed in claim 1, wherein the sheet-like discrete element has a coefficient of linear thermal expansion α in a range from 2.0*10⁻⁶/K to 10*10⁻⁶/K.

9. The electrical storage system as claimed in claim 1, wherein the sheet-like discrete element has a maximum load temperature θ_{Max} of at least 300° C., a coefficient of linear thermal expansion α in a range from 2.0*10⁻⁶/K to 10*10⁻⁶/K, and a product of the maximum load temperature and the coefficient of linear thermal expansion of 600·10⁻⁶≦θ_{Max}·α≦8000·10⁻⁶.

10. The electrical storage system as claimed in claim 1, wherein the sheet-like discrete element is a glass.

11. The electrical storage system as claimed in claim 10, wherein the sheet-like discrete element is a drawn glass

12. A sheet-like discrete element for use in an electrical storage system, comprising:
a transmittance selected from the group consisting of: 20% or less in a range from 200 nm to 270 nm at a thickness of 30 μm, 2.0% or less at 222 nm at a thickness of 30 μm, 1.0% or less at 248 nm at a thickness of 30 μm, 50% or less at 282 nm at a thickness of 30 μm, 85% or less at 308 nm at a thickness of 30 μm, 92% or less at 351 nm at a thickness of 30 μm, 3% or less in a range from 200 nm to 270 nm at a thickness of 100 μm, 3.0% or less at 222 nm at a thickness of 100 μm, 3.0% or less at 248 nm at a thickness of 100 μm, 20% or less at 282 nm at a thickness of 100 μm, 75% or less at 308 nm at a thickness of 100 μm, and 92% or less at 351 nm at a thickness of 100 μm;
a total thickness variation of not more than 25 μm based on wafer or substrate sizes in a range of >100 mm in diameter; and
a composition range, in wt %, of:

| Component | Range |
|---|---|
| SiO₂ | 30-85 |
| Al₂O₃ | 0-15 |
| B₂O₃ | 3-20 |
| Na₂O | 3-15 |
| K₂O | 3-15 |
| CaO | 0-0.1 |
| ZnO | 0-12 |
| TiO₂ | 0.5-10. |

13. The sheet-like discrete element as claimed in claim 12, wherein the transmittance is selected from the group consisting of 15% or less in the range from 200 nm to 270 nm at a thickness of 30 μm, 10% or less at 282 nm at a thickness of 30 μm, and 80% or less at 308 nm a thickness of 30 μm.

14. The sheet-like discrete element as claimed in claim 12, further comprising a water vapor transmission rate (WVTR) of <10⁻³ g/(m²·d).

15. The sheet-like discrete element as claimed in claim 12, further comprising a thickness of less than 2 mm.

16. The sheet-like discrete element as claimed in claim 12, further comprising a thickness of not more than 100 μm.

17. The sheet-like discrete element as claimed in claim 12, further comprising a specific electrical resistance at a temperature of 350° C. and at alternating current with a frequency of 50 Hz of greater than 1.0*10⁶ Ohm·cm.

18. The sheet-like discrete element as claimed in claim 12, further comprising a maximum load temperature θ_{Max} of at least 300° C.

19. The sheet-like discrete element as claimed in claim 12, further comprising a coefficient of linear thermal expansion α in a range from 2.0*10⁻⁶/K to 10*10⁻⁶/K.

20. The sheet-like discrete element as claimed in claim 12, further comprising a maximum load temperature θ_{Max} of at least 300° C., a coefficient of linear thermal expansion α in a range from 2.0*10⁻⁶/K to 10*10⁻⁶/K, and a product of the maximum load temperature and the coefficient of linear thermal expansion of 600·10⁻⁶≦θ_{Max}·α≦8000·10⁻⁶.

21. The sheet-like discrete element as claimed in claim 12, wherein the element is made of glass.

22. The sheet-like discrete element as claimed in claim 21, wherein the glass comprises drawn glass.

23. A method for producing a thin film storage element, comprising:
providing a sheet-like discrete element;
depositing a functional layer on the sheet-like discrete element; and
processing the functional layer by focusing UV light onto the sheet-like discrete element which thereby absorbs the UV radiation and converts the UV radiation into heat energy, the heat energy thermally post-treating the functional layer.
